(19) United States
(12) Patent Application Publication
(10) Pub. No.: US 2026/0300464 A1
(43) Pub. Date: Oct. 1, 2026

(54) Adaptive Two-Factor Authentication System and Method Based on AI-driven Risk Assessment with Out-of-Band OTP Transmission

(71) Applicant: Insoo Kim, Paju-si (KR)

(72) Inventor: Insoo Kim, Paju-si (KR)

(21) Appl. No.: 19/428,119

(22) Filed: Dec. 20, 2025

(30) Foreign Application Priority Data
Apr. 1, 2025 (KR) 10-2025-0042456

(51) Int. Cl. G06F 21/42; H04L 9/32

(52) U.S. Cl. CPC G06F 21/42; H04L 9/3228

(57) ABSTRACT

The invention provides an adaptive two-factor authentication (2FA) system that dynamically generates one-time passwords (OTPs) based on real-time, AI-driven risk assessment. The system collects contextual metadata, including time, IP address, geographic location, device and browser profiles, and user history, and computes a risk score using a trained machine-learning model. According to the risk score, OTP properties are adjusted, including length, character set and complexity, validity period, and number and type of out-of-band channels. An independent out-of-band (OOB) server, physically and logically separated from the primary authentication server, generates and delivers the OTP via selected out-of-band channels such as a mobile application or email, and may trigger an administrator alert. Under high-risk conditions the system strengthens OTP policies and shortens validity, thereby improving resistance to phishing, man-in-the-middle, replay, and session-hijacking attacks while balancing security with user convenience.

### CROSS-REFERENCE TO RELATED APPLICATION

This application claims priority to and the benefit of Korean Patent Application No. 10-2025-0042456, filed on Apr. 1, 2025, the entire contents of which are incorporated herein by reference.

### FIELD OF THE INVENTION

The present invention relates to user authentication systems, and more particularly, to an adaptive two-factor authentication (2FA) system and method that dynamically generates one-time passwords (OTPs) based on real-time risk assessment using artificial intelligence (AI), and delivers the OTP through an independent out-of-band (OOB) channel to enhance security and resilience against cyberattacks.

### BACKGROUND OF THE INVENTION

Conventional OTP-based 2FA systems typically rely on static six-digit numeric OTPs, which do not reflect contextual risk factors of the login environment. Such systems are vulnerable to phishing, man-in-the-middle (MitM) attacks, and session hijacking.

Moreover, in most existing systems, the OTP is generated and transmitted through the same in-band channel as the login request, making it susceptible to interception.

Risk-based authentication (RBA) has been introduced to assess login contexts; however, existing RBA systems generally adjust authentication requirements (e.g., challenge vs. no challenge) without dynamically modifying the OTP itself. Thus, there is a need for a system that adaptively adjusts the OTP properties according to real-time risk assessment, while transmitting OTPs via physically and logically isolated channels for improved security.

### SUMMARY OF THE INVENTION

The invention provides an adaptive authentication system comprising:
a machine-learning-based risk assessment engine that computes a real-time risk score from contextual metadata,
an OTP policy decision module that dynamically adjusts OTP properties (length, character set, validity period, delivery channels) according to the risk score, and
an out-of-band OTP generation and transmission module, isolated from the primary authentication server, which delivers OTPs through secure multi-channel communication.

The invention improves security by:
dynamically strengthening OTPs under high-risk conditions,
mitigating phishing and MitM attacks through OOB delivery,
enabling administrator alerts for rapid incident response.

### Abbreviations and Definitions

As used herein, the following terms have the meanings indicated.
out-of-band (OOB): a communication path that is physically and logically isolated from the primary authentication channel/server.
one-time password (OTP): a single-use authentication code whose properties may be dynamically adjusted.
time-to-live (TTL): the validity period of an OTP.
risk-based authentication (RBA): authentication behavior that adapts to a computed risk score.
machine-learning (ML) model: a trained classifier used to compute the risk score from a feature vector.
feature vector: a structured representation of contextual metadata, which may include normalized or encoded IP address ranges, device and browser fingerprints, coarse geolocation buckets, temporal features, and historical behavior aggregates.

### BRIEF DESCRIPTION OF THE DRAWINGS

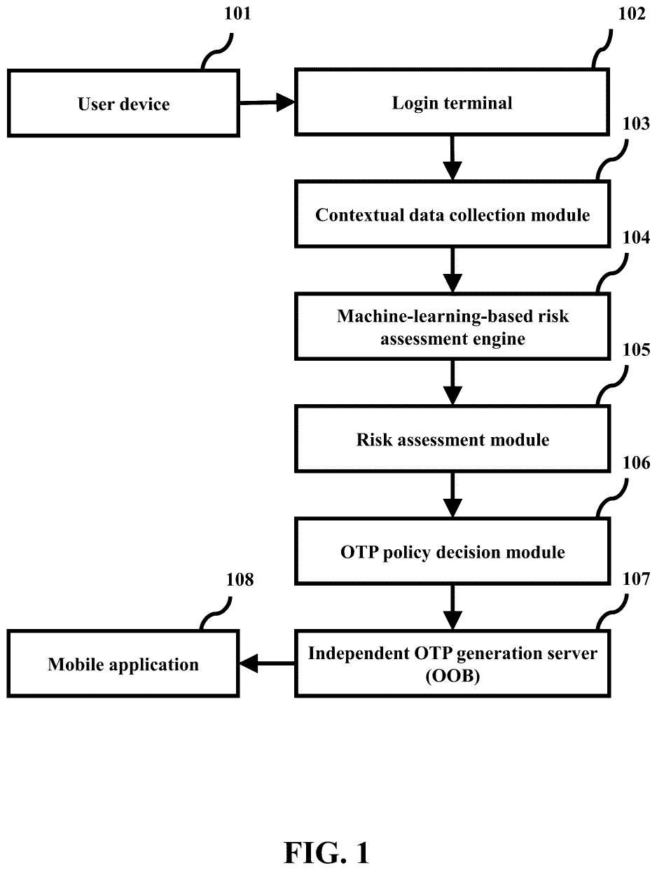

### FIG. 1.

FIG. 1 illustrates a system architecture of the adaptive two-factor authentication system, including a user device, contextual data collection module, risk assessment engine, risk assessment module, OTP policy decision module, OTP generation server (out-of-band), and mobile application. The system includes a user device (101), login terminal (102), contextual data collection module (103), machine-learning-based risk assessment engine (104), risk assessment module (105), OTP policy decision module (106), independent OTP generation server (OOB) (107), and mobile application (108).

Feature Vector Preprocessing. In certain embodiments, the contextual metadata collected by the contextual data collection module (103) is preprocessed and converted into a structured feature vector for input to the machine-learning model of the risk assessment engine (104). The feature vector may include normalized and encoded representations of IP address ranges, device and browser fingerprints, coarse geolocation buckets (e.g., country/region), temporal features (e.g., hour-of-day, day-of-week), and historical behavior aggregates. The risk assessment module (105) consumes the model output and normalizes the risk score to a value between 0.0 and 1.0 for use by the OTP policy decision module.

| | | | Notes |
|---|---|---|---|
| Reference | | | (installation, |
| No. | Component | Function | communication, etc.) |
| 101 | User device | Initiates login request and | End user in web or mobile |
| | | enters OTP for authentication | environment |
| 102 | Login terminal | Device through which the user | PC, smartphone, kiosk, or |
| | | submits login requests and | client device |
| | | inputs OTP | |
| 103 | Contextual data | Collects and preprocesses | Located on login server or |
| | collection module | metadata (IP, time, device info, | proxy gateway |
| | | etc.) for risk assessment | |
| 104 | Machine-learning- | Performs risk prediction using | Implemented as Random |
| | based risk assessment | collected metadata and a trained | Forest, XGBoost, etc. |
| | engine | ML model | |
| 105 | Risk assessment | Computes normalized risk score | Integrated with OTP policy |
| | module | (0.0-1.0) for OTP policy | logic |
| | | adjustment | |
| 106 | OTP policy decision | Dynamically determines OTP | Executes thresholded rules |
| | module | attributes based on the risk | and lookup tables; outputs a |
| | | score | signed policy token |
| | | | consumed by the Independent |
| | | | OTP generation server |
| | | | (OOB) (107). |
| 107 | Independent OTP | Dynamically generates OTP | Operated on an independent |
| | generation server | based on risk score and delivers | server, physically/logically |
| | (OOB) | via out-of-band channels | isolated from the primary |
| | | | authentication server |
| 108 | Mobile application | Receives and displays OTP to | Receives via OOB channels |
| | | user, guides OTP entry | on user's smartphone |

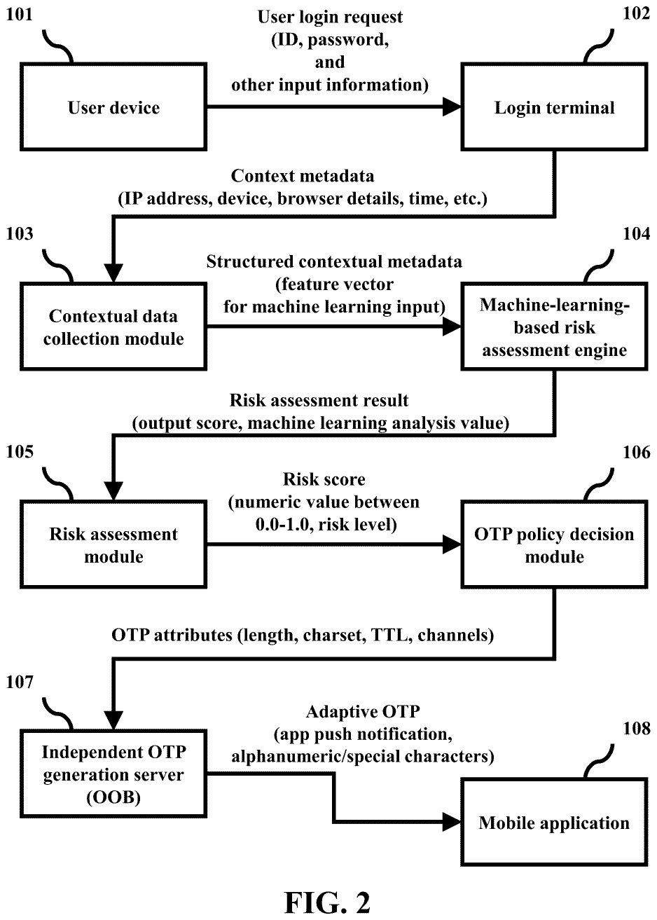

### FIG. 2.

FIG. 2 is a flowchart depicting the process of risk-based OTP property adjustment, OTP generation, and OOB transmission. The flowchart illustrates the sequence of operations performed by the adaptive two-factor authentication system. In particular, the process proceeds as follows:
1. User login request is submitted from a client device.
2. Login server collects contextual metadata (e.g., IP address, device profile, time, location) and forwards it to the risk assessment. During step 2, the system generates a feature vector from the collected metadata and provides the feature vector as input to the trained machine-learning classifier to compute the risk score.
3. Risk assessment engine computes a risk score using a trained machine-learning model.
4. OTP policy decision module determines OTP properties (length, character set, validity period, transmission channel, administrator alert) according to the computed risk score.
5. Validity Period Examples. By way of example, under high-risk conditions the OTP validity period may be set to less than 30 seconds (e.g., 20-30 s), whereas under low-risk conditions it may be about 60 seconds. The policy may further map intermediate risk bands to intermediate validity periods (e.g., 30-45 s).
6. OTP generation server (out-of-band) generates the OTP and transmits it via selected out-of-band (OOB) channels (e.g., mobile application, email, administrator alert).
7. User enters OTP into the login interface.
8. Primary authentication server validates the OTP and completes the authentication process.

### DETAILED DESCRIPTION OF THE PREFERRED EMBODIMENTS

### System Architecture (FIG. 1)

The adaptive authentication system includes:
User Device (101): Generates login requests and receives OTP input.
Login Terminal (102): Client interface where the login is initiated.
Contextual Data Collection Module (103): Collects metadata such as IP address, device information, time, and geolocation.
Machine-Learning-Based Risk Assessment Engine (104): Employs a trained machine-learning classifier (e.g., Random Forest, Gradient Boosting) to evaluate the legitimacy of login requests.
Risk Assessment Module (105): Produces a normalized risk score (0.0-1.0) that serves as the basis for OTP policy adjustment.
OTP Policy Decision Logic. Given a risk score r in [0, 1], the system selects (length, charset, TTL, channels) by evaluating thresholded rules and lookup tables stored in the OTP policy decision module. The module executes on dedicated server-side processes and outputs a signed policy token that is consumed by the OTP generation server (OOB) to generate and deliver the OTP according to the determined attributes.
OTP Policy Decision Module (106): Dynamically determines OTP attributes, including length, character set, validity period (TTL), number and type of out-of-band channels, and whether to trigger an administrator alert, based on the normalized risk score by evaluating thresholded rules and lookup tables, and outputs a signed policy token consumed by the OTP generation server (OOB).
Independent OTP Generation Server (107): Generates OTPs according to dynamic policies and transmits them through out-of-band channels, independent of the primary authentication server.
Mobile Application (108): Receives OTPs and guides the user to complete the login process.

### Method of Operation (FIG. 2)

1. A login request is received from the user device.
2. Metadata is collected and forwarded to the risk assessment engine.
3. The risk assessment engine computes a risk score.
4. The OTP policy decision module adjusts OTP properties (e.g., extending OTP length, including alphanumeric and special characters, reducing validity period).
   Risk-to-Policy Mapping Examples. In one implementation, the policy maps normalized risk-score bands to OTP attributes as follows: 0.0-0.3 (a range from 0.0 to 0.3)->6-8 digits, alphanumeric, TTL about 60 s, single channel; 0.3-0.6 (a range from 0.3 to 0.6)->8-10 characters, alphanumeric with at least one special character, TTL 30-45 s, one or two channels; >=0.6 (0.6 or greater)->>=10 (10 or more) characters including digits, mixed case and special characters, TTL 20-30 s, multiple channels with an administrator alert.
5. The OTP generation server (out-of-band) generates the OTP and transmits it via selected out-of-band channels (e.g., mobile application, email, administrator alert).
   OOB Transport Details. The OTP generation server (OOB) communicates over mutually authenticated TLS, attaches a per-message nonce and expiration timestamp to prevent replay, and enforces idempotent delivery via message identifiers across mobile application and email channels.
6. The user inputs the OTP for verification, and the system authenticates the login.

### Experimental Validation

In experimental testing with 5,000 login attempts, the proposed system reduced phishing success rates from 82% (static OTP) to 14%, and rendered brute-force attacks infeasible due to increased complexity and shortened OTP validity.

1. An adaptive two-factor authentication system, comprising:
a risk assessment module configured to calculate a real-time risk score of a login request based on context metadata collected at a time of the login request;
an OTP policy determination module configured to dynamically adjust at least one attribute of a One-Time Password (OTP) according to the calculated risk score; and
an independent OTP generation and transmission module configured to generate the OTP based on the adjusted attribute and transmit the OTP through an out-of-band (OOB) communication channel that is physically and logically isolated from a primary authentication path,
wherein, in response to the risk score exceeding a threshold, the system increases OTP complexity, utilizes multiple delivery channels, and triggers an administrator alert.

2. The system of claim 1, wherein the context metadata comprises login time, IP address, geographic location, device information, browser information, and historical login patterns, and the risk assessment module is configured to normalize the risk score to a value between 0.0 and 1.0.

3. The system of claim 1, wherein the machine-learning model comprises a classifier selected from the group consisting of a Random Forest classifier and a Gradient Boosting classifier trained on historical login data.

4. The system of claim 1, wherein the context metadata is converted into a structured feature vector for input into the machine-learning model.

5. The system of claim 1, wherein the OTP policy determination module is configured to select at least one of an OTP length, a character set, and a validity period as the adjusted attribute.

6. The system of claim 5, wherein the OTP length is increased and the validity period is shortened as the risk score increases.

7. The system of claim 5, wherein the character set is adjusted to include at least one of uppercase letters, lowercase letters, and special characters when the risk score exceeds a predetermined threshold.

8. The system of claim 1, wherein the out-of-band (OOB) communication channel comprises at least one of a push notification to a mobile application, an SMS message, and an email.

9. The system of claim 1, wherein the independent OTP generation and transmission module is configured to transmit the OTP through a plurality of out-of-band channels simultaneously in response to the risk score exceeding a threshold.

10. The system of claim 1, wherein the administrator alert is transmitted via a secure management channel distinct from the out-of-band communication channel used for the OTP.

11. An adaptive two-factor authentication method, comprising: calculating, by a risk assessment module, a real-time risk score of a login request based on context metadata collected at a time of the login request; dynamically adjusting, by an OTP policy determination module, at least one attribute of a One-Time Password (OTP) according to the calculated risk score; and generating, by an independent OTP generation module, the OTP based on the adjusted attribute and transmitting the OTP through an out-of-band (OOB) communication channel that is physically and logically isolated from a primary authentication path.

12. The method of claim 11, wherein calculating the risk score comprises converting the context metadata into a structured feature vector and processing the vector using a trained machine-learning model.

13. The method of claim 11, wherein adjusting the OTP attribute comprises selecting an OTP length and a character set that increase in complexity as the risk score increases.

14. The method of claim 11, wherein adjusting the OTP attribute comprises shortening a validity period of the OTP in response to the risk score exceeding a threshold.

15. The method of claim 11, wherein transmitting the OTP comprises sending the OTP via multiple out-of-band channels to mitigate interception or replay attacks.

16. The method of claim 11, further comprising, when the risk score exceeds a threshold, automatically issuing an administrator alert in parallel with the OTP transmission.

17. The method of claim 11, wherein the risk score is normalized to a range from 0.0 to 1.0, and the OTP attribute is determined by a policy mapping the normalized risk score to a specific security level.

18. A non-transitory computer-readable storage medium storing instructions that, when executed by one or more processors, cause the processors to perform the method of claim 11.

19. The non-transitory computer-readable storage medium of claim 18, wherein the instructions further cause the processors to generate a structured feature vector from the context metadata prior to computing the risk score.

20. The non-transitory computer-readable storage medium of claim 18, wherein the instructions further cause the processors to select one or more out-of-band channels from a group consisting of a mobile application, email, and an administrator alert channel, based on the risk score.
